(19) United States
(12) Patent Application Publication
(10) Pub. No.: US 2014/0259897 A1
(43) Pub. Date: Sep. 18, 2014

(54) Infinitely Variable Planting or Spraying Device

(71) Applicant: AGCO CORPORATION, Duluth, GA (US)

(72) Inventors: Ravindra Godbole, Duluth, GA (US); John Peterson, Jackson, MN (US)

(73) Assignee: AGCO CORPORATION, Duluth, GA (US)

(21) Appl. No.: 13/804,470

(22) Filed: Mar. 14, 2013

(51) Int. Cl. A01C 23/00; A01C 21/00

(52) U.S. Cl. CPC A01C 23/008; A01C 21/002
USPC 47/1.5; 239/159; 239/1

(57) ABSTRACT

In one embodiment, an applicator system comprising a beam; an applicator transducer; an applicator hose system coupled to the beam and the applicator transducer, the applicator hose system comprising: a trolley system configured to move bi-directionally along the beam based on a cable-pulling operation of the applicator transducer; a hose carrier configured to carry at least a portion of a hose; and an applicator that is coupled to one end of the hose carried by the hose carrier and operably coupled to the trolley system.

### TECHNICAL FIELD

The present disclosure is generally related to agricultural systems and methods, and, more particularly, to product dispensing systems.

### BACKGROUND

Today's farm equipment utilizes row units/nozzles to plant seeds or dispense crop protection products. For instance, in the case of planting (with similar applicability to spraying), row units (like spray nozzles) are added to achieve the desired working width, and seed plates and drive units are utilized to achieve plant spacing within a row. Such methods typically make use of broad acre preparation of the soil ahead of the row units, and the final plant stand is dependent on actual seed spacing, depth control of the seed, and the final soil-to-seed contact.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a simplified schematic diagram that illustrates, in overhead, fragmentary view, an example agriculture machine in which certain example embodiments of applicator systems may be used.

FIG. 2 is a schematic diagram in front elevation view of a portion of a boom equipped with an example embodiment of an applicator system.

FIG. 3 is a schematic diagram in rear elevation view of the portion of the boom of FIG. 2.

FIGS. 4A-4B are schematic diagrams showing in front perspective views an example embodiment of an applicator system.

FIG. 5 is a schematic diagram showing an example embodiment of an applicator transducer of the applicator system of FIG. 4A.

FIG. 6 is a schematic diagram showing in partial cut-away view an example embodiment of a trolley system of the applicator system of FIG. 4A.

FIG. 7A is a block diagram that illustrates an example embodiment of a command and control system.

FIG. 7B is a block diagram that illustrates an example embodiment of a control system for the command and control system of FIG. 7A.

FIG. 8 is a flow diagram of an embodiment of an example applicator method.

### DESCRIPTION OF EXAMPLE EMBODIMENTS

### Overview

In one embodiment, an applicator system comprising a beam; an applicator transducer; an applicator hose system coupled to the beam and the applicator transducer, the applicator hose system comprising: a trolley system configured to move bi-directionally along the beam based on a cable-pulling operation of the applicator transducer; a hose carrier configured to carry at least a portion of a hose; and an applicator that is coupled to one end of the hose carried by the hose carrier and operably coupled to the trolley system.

### DETAILED DESCRIPTION

Certain embodiments of an applicator system and method are disclosed that enable precision farming and facilitate the implementation of autonomous farming. The applicator system may be used in planting or spraying applications, and in one embodiment, comprises a beam, an applicator hose system coupled to the beam, and an applicator transducer that drives the applicator hose system in a bi-directional manner. The applicator hose system includes an applicator (e.g., a spray nozzle assembly, including controlled droplet applicators, or planter row unit or planter head) that dispenses product (e.g., seed, fertilizer, herbicides, pesticides, etc.) to the field in a precise and selective manner based on the controlled-positioning along the length of the beam.

Digressing briefly, a typical boom comprises plural applicators along the length of the boom, each dedicated to dispensing product along a given row as the agriculture machine advances along a forward path in the field. Accordingly, there is very little flexibility in the placement of product and/or pattern of dispensing the product. Certain embodiments of applicator systems represent a rethinking or redefinition of traditional applicator systems, enabling a reduction in the quantity of applicators (e.g., to one in some embodiments) and the implementation of spot, product application (e.g., spot preparation, fertilization, and precise placement of the seed for planting or precise spray patterns with adjustments in droplet size, speed, etc.). Further, the flexibility of certain embodiments of applicator systems enables planting and/or spraying in unconventional patterns (e.g., corn maize).

Having summarized certain features of applicator systems of the present disclosure, reference will now be made in detail to the description of the disclosure as illustrated in the drawings. While the disclosure will be described in connection with these drawings, there is no intent to limit it to the embodiment or embodiments disclosed herein. For instance, though emphasis is placed hereinafter on spraying systems, certain embodiments of applicator systems are applicable to planting systems. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Referring now to FIG. 1, shown is a simplified schematic of an agriculture machine embodied as a self-propelled sprayer machine 10, which provides an example environment in which an applicator system 12 may be implemented. Although a sprayer machine 10 is shown, it should be appreciated within the context of the present disclosure that certain embodiments of applicator systems 12 may be used in towed, farm implements and/or other agriculture machines, such as planters. Certain features of sprayer machines well known to those having ordinary skill in the art are omitted in FIG. 1 for brevity. The sprayer machine 10 comprises a cab 14 and a tank 16 that mounts on a chassis. The cab 14 comprises a control system 18 that provides operational control of the sprayer machine 10 and its various subsystems, as well as providing an operator interface for local or remote control of the sprayer machine 10. Note that some embodiments may utilize automated machines that need not have an operator residing in the cab 14 (or elsewhere), or in some embodiments, the sprayer machine 10 may be operated via remote control. The control system 18 is depicted in FIG. 1 as residing in the cab 14, though in some embodiments, the control system 18 may comprise a plurality of communicatively coupled components that are distributed throughout the sprayer machine 10. The tank 16 stores liquid fluid for use in dispensing to targets located in a field traversed by the sprayer machine 10. The sprayer machine 10 further comprises wheels 20 to facilitate traversal of a given field, though some embodiments may utilize tracks. It should be appreciated that the axle arrangement depicted in FIG. 1 is merely illustrative, and that other arrangements are contemplated to be within the scope of the disclosure.

The sprayer machine 10 further comprises a boom 22 that extends out from the rear of the sprayer machine 10 to both sides of the sprayer machine 10 in known manner. As is described below, in one embodiment, the boom 22 comprises a beam that couples to the boom 22, an applicator transducer, a conduit that supports a hose for carrying fluid, and an applicator hose system that includes a trolley system, hose carrier, and an applicator 24. In some embodiments, there may be a plurality of applicator hose systems on each side of the boom 22 (e.g., each side of the tank 16), or in some embodiments, only a single applicator hose system on each side of the boom 22 or on a single boom (e.g., where movement of the applicator 24 is allowed across the vehicle via a contiguous boom). The applicator 24 may be embodied as nozzle assembly, which may include one or more nozzles with different performance characteristics (e.g., droplet size, fluid velocity, spray pattern, etc.). The applicator transducer and applicator hose system may operate according to a mechanical, hydraulic, and/or electrical system that is responsive to signals provided by the control system 18.

The sprayer machine 10 navigates across a field to dispense fluid from one or more applicator(s) 24 and onto various targets. The applicator(s) 24 may dispense fluids (e.g., chemicals) on crops, bare ground, pests, etc., as pre-emergence and/or post-emergence herbicides, fungicides, and insecticides.

Referring now to FIG. 2, shown is a front schematic view of the right hand side boom 22 of FIG. 1. Various portions of the applicator system 12 are obscured from view by a front guard 26, which is secured to the boom 22. However, noteworthy from FIG. 2 is that a lower frame member 28 of the boom 22 is coupled to a beam (obscured by the front guard 26) of the applicator system 12 using securing mechanisms, such as U-bolts 30 positioned at defined locations along the boom 22 as depicted in the example of FIG. 2.

Turning attention to FIG. 3, shown is a rear schematic view of the right hand side boom 22 shown in FIG. 2. The rear-view side of the front guard 26 is shown, which comprises plural support brackets or hooks 32 that are used to support a conduit 34 adjacent a lower edge of the front guard 26. Other mechanisms for supporting the conduit 34 are contemplated to be within the scope of the disclosure. The conduit 34 may be configured as a metal (or other material) tray. The conduit 34 supports a hose 36 (or equivalently, any other fluid carrying conduit, such as tubing) that is fluidly coupled to the tank 16 (FIG. 1) (directly in some embodiments, or indirectly via an intervening valve, such as a shut-off valve (e.g., electrically actuated), and/or other hose coupled to the tank 16). The hose 36 at least partially runs through a well-known hose carrier 38, which may be comprised of metal or other material. The hose carrier 38 is coupled to the applicator 24, enabling flexible support of the hose 36 as the applicator 24 is positioned along the length of the right hand side portion of the boom 22. The applicator 24 is coupled to a trolley system (not shown in FIG. 3), which moves bi-directionally along a length of a beam 40 that is secured to the right hand side of the boom 22 via the U-bolts 30.

Referring now to FIGS. 4A-4B, shown are schematic views of an embodiment of the applicator system 12. It should be appreciated within the context of the present disclosure that some embodiments of applicator systems may have fewer, additional, and/or different components than those depicted in FIGS. 4A-4B. With regard to FIG. 4A, an embodiment of the applicator system 12 comprises the beam 40, the conduit 34 and the hose 36 resting on the conduit 34, and an applicator transducer 42. The applicator transducer 42 is coupled to the beam 40, and in one embodiment is located proximal to the end of the beam 40 (e.g., left hand end, or stated otherwise, on the side closest to the tank 16 (FIG. 1)). The applicator system 12 further comprises an applicator hose system 44, which in one embodiment, comprises a trolley system 46, the applicator 24, the hose carrier 38, the hose 36, and a valve (e.g., check valve) 48 disposed between the hose 36 carried by the hose carrier 38 and the applicator 24.

In one embodiment, the beam 40 comprises a uni-strut beam that is slotted on the top side of the beam 40. The beam 40 is secured to the boom 22 (FIG. 3) via the U-bolts 30 that are secured at slots of the beam 40 and to the lower frame member 28 (FIG. 3) of the boom 22. The U-bolts 30 can be relocated along the beam 40, resulting in a universal implement for different types of booms. The trolley system 46 moves bi-directionally along the beam 40, enabling the applicator 24 to be positioned along an infinite amount of positions along the boom 22. The applicator 24 is shown as a multi-nozzle (e.g., three (3) nozzles) assembly, wherein the nozzles are distinct from one another according to performance features, as is known in the art. Disposed adjacent the applicator 24 is the valve 48. The valve 48 may be embodied as a check valve, and is disposed between an outlet end of the hose 36 carried by the hose carrier 38 and an inlet to the body of the applicator 24. As is known, the valve 48 enables fluid flow in one direction, ensuring fluid is present in the hose 36 even when the applicator 24 is shut-off (e.g., when no fluid dispensed from the applicator 24).

Also shown in FIG. 4A is the conduit 34 supporting at least a portion of the hose 36. The conduit 34 is depicted as a tray upon which the hose 36 rests. The conduit 34 is supported by the front guard 26 by the brackets 32, though other mechanisms for supporting the conduit 34 well-known in the art may be used.

Referring to FIG. 4B, shown is the hose carrier 38, which surrounds and supports the hose 36. In one embodiment, the hose carrier 38 carries the hose 36 over a defined length (e.g., approximately seven (7) feet) with no support. By providing a carrier support 50 in the middle of the entire length of the hose carrier 38 (e.g., versus the end), as shown in FIG. 4B, the hose travel doubles (e.g., to fourteen (14) feet). At the carrier support 50, the hose 36 bends and enters an inlet end of the hose carrier 38.

Attention is directed now to FIG. 5, which shows an embodiment of the applicator transducer 42. The applicator transducer 42 comprises a cable 52 and a drive system comprising a pulley 54 (around which the cable 52 is routed), a motor 56, a gearbox 58, an encoder 60, and one or more limit switches, such as limit switch 62. In one embodiment, the motor 56 comprises a DC motor, though in some embodiments, it may be driven via AC. The limit switch(es) 62 may be used to prevent overfeed caused by misalignment, as well as to recalibrate the position of the applicator 24 (FIG. 4A). The encoder 60 receives a signal (e.g., analog or digital) from the control system 18 (FIG. 1), and based on that signal, causes the motor 56 to power the gearbox 58. The gearbox 58, as powered by the motor 56, causes the pulley 54 to drive the cable 52 in a rotational direction and for a defined duration (and hence cable travel) as translated by the encoder 60. The movement by the cable 52 (and hence the trolley system 46 and coupled applicator 24 of FIG. 4A) may be continuous, or in some embodiments, step-wise or incremental.

Referring now to FIG. 6, shown is an embodiment of the trolley system 46. It should be appreciated that the example trolley system 46 is merely one example for positioning the applicator 24, and that other mechanisms to achieve the same or similar function may be used and hence are contemplated to be within the scope of the disclosure. The trolley system 46 comprises a frame 64 that is coupled on each end to the cable 52. The cable 52 may be viewed, in snapshot, as comprising a lower portion 52A that is secured to the frame 64, and an upper portion 52B that resides within the beam 40, shown in partial cut-away to reveal some of the trolley components. The frame 64 is also coupled to the applicator 24 via bracket 66. In one embodiment, the bracket 66 may be directly coupled to the hose carrier 38, through which the applicator 24 is indirectly coupled to the frame 64. In one embodiment, the bracket 66 may be coupled to the valve 48, through which the applicator 24 is indirectly coupled to the frame 64. In some embodiments, the bracket 66 may be coupled directly to the body of the applicator 24, or in some embodiments, a combination of these coupling arrangements (e.g., direct and/or indirect). The trolley system 46 further comprises one or more rollers, such as roller 68. The roller 68 enables the trolley system 46 to ride along, and be guided by, the interior surfaces of the beam 40 as the frame 64 is driven in one direction or the other by the applicator transducer 42 (FIG. 5). The roller frame or axle assembly is coupled to the frame 64 by well-known securing elements, such as a bolt 70. It should be appreciated that the trolley system functionality may be employed in other ways according to well-known mechanisms, and hence these other mechanisms are contemplated to be within the scope of the disclosure.

FIG. 7A illustrates an embodiment of a command and control system 72 for controlling various functions of the sprayer machine 10 (FIG. 1). It should be appreciated within the context of the present disclosure that some system embodiments may include additional components, fewer, or different components, and that the example depicted in FIG. 7A is merely illustrative of one embodiment among others. The command and control system 72 comprises the control system 18 coupled via a network 74 to a guidance system receiver 76, machine controls 78, and a user interface 80. One or more control systems 18 may be implemented in a command and control system 72. The network 74 may be configured as a wired and/or wireless network. For instance, in one embodiment, the network 74 comprises a CAN network, though not limited to a CAN network and not limited to a single network. The guidance system receiver 76 includes the capability to access one or more constellations (e.g., global positioning systems (GPS), GLONASS, Galileo, among other constellations, including hybrids of these constellations) jointly or separately. The machine controls 78 collectively comprise the various actuators, servos, sensors, and/or subsystems (e.g., steering, the applicator transducer 42, drivetrain, etc.) residing on the sprayer machine 10 (FIG. 1), including those used to control machine navigation (e.g., speed, direction), implement (e.g., header or trailer) position and/or control, internal machine processes, applicator hose system positioning, nozzle selection, among others. The user interface 80 may be a keyboard, mouse, microphone, touch-type display device, joystick, steering wheel, or other devices (e.g., switches) that enable input by an operator. The guidance system receiver 76, as is known, may enable autonomous or semi-autonomous operation of the sprayer machine 10 in cooperation with the machine controls 78 and the control system 18 (e.g., via guidance software residing in memory in the control system 18). The control system 18 is configured to receive and process the information from the guidance system receiver 76, the machine controls 78, and/or the user interface 80.

FIG. 7B further illustrates an example embodiment of the control system 18. One having ordinary skill in the art should appreciate in the context of the present disclosure that the example control system 18 is merely illustrative, and that some embodiments of controllers may comprise fewer or additional components, and/or some of the functionality associated with the various components depicted in FIG. 7B may be combined, or further distributed among additional modules, in some embodiments. In some embodiments, all or a portion of the functionality of the control system 18 may be incorporated in additional components of the sprayer machine 10, with such an arrangement achieving a peer-to-peer or master-slave type of control. The control system 18 is depicted in this example as a computer system, but may be embodied as a programmable logic controller (PLC), FPGA, among other devices. It should be appreciated that certain well-known components of computer systems are omitted here to avoid obfuscating relevant features of the control system 18. In one embodiment, the control system 18 comprises one or more processing units, such as processing unit 82, input/output (I/O) interface(s) 84, and memory 86, all coupled to one or more data busses, such as data bus 88.

The memory 86 may include any one or a combination of volatile memory elements (e.g., random-access memory RAM, such as DRAM, and SRAM, etc.) and nonvolatile memory elements (e.g., ROM, hard drive, tape, CDROM, etc.). In general, the memory 86 may store a native operating system, one or more native applications, emulation systems, or emulated applications for any of a variety of operating systems and/or emulated hardware platforms, emulated operating systems, etc. For instance, In the embodiment depicted in FIG. 7B, the memory 86 comprises an operating system 90, applicator system software 92, guidance software 94, and field maps 96. It should be appreciated that in some embodiments, additional or fewer software modules (e.g., combined functionality) may be employed in the memory 86 or additional memory. In some embodiments, a separate storage device may be coupled to the data bus 88, such as a persistent memory (e.g., optical, magnetic, and/or semiconductor memory and associated drives).

Execution of the software modules 90-94 may be implemented by the processing unit 82 under the management and/or control of the operating system 90. In some embodiments, the operating system 90 may be omitted and a more rudimentary manner of control implemented.

In some embodiments, the one or more field maps 96 may be recorded from a prior traversal of a given field, or currently recorded, enabling autonomous or semi-autonomous traversal of a given field when activated. In some embodiments, the field maps 96 may be loaded into the control system 18 via a removable memory or via communications from a remote device to transceiver functionality associated with the I/O interfaces 84.

The guidance software 94 may coordinate inputs from the guidance system receiver 76 (FIG. 7A) and, based on the field maps 96, output control signals to one or more machine controls 78 to enable guided traversal and/or performance of various farming operations on a field.

The applicator system software 92 may operate in conjunction with the guidance software 94, the field maps 96, and machine controls 78 (FIG. 4A) to apply product in a precise manner to a field. For instance, a spraying plan may be loaded into the memory 86, retrieved by the applicator system software 92, and based on the field map data and/or other operational parameters, determine appropriate positioning of the applicator hose system 44 (FIG. 4A) along the beam 40 (FIG. 4A) for precise and complete product dispensing. Also, the plan may indicate the type of applicator 24 (FIG. 4A) to use for dispensing product in a given area, which enables the selection of the type of applicator 24 for use in that area. In some embodiments, control signals from the control system 18 to an actuator associated with the applicator (which may be the applicator transducer 42, or some other actuator of the machine controls 78 (FIG. 7A)) may cause the nozzle type of a multi-nozzle assembly to be selected, which is then positioned into place for dispensing.

As one example implementation, with the understanding that variations of the below may be implemented depending on the need or plan, as the sprayer machine 10 (FIG. 1) advances in a field, the sprayer machine 10 may position the applicator hose system 44 (FIG. 4A) at a given location along the beam 40 (FIG. 4A), select the appropriate nozzle of the applicator 24 (FIG. 4A), and dispense product. A next step in the process may be to position the applicator hose system 44 to another location along the beam 40 (e.g., in a direction transverse to the direction of travel), select the appropriate nozzle (if change is needed), and dispense the product, and continue this process until the sprayer machine 10 is directed to advance forward for the next row of plants.

Although described above for spraying applications, it should be appreciated within the context of the present disclosure that other types of applications, such as planting, may be used and hence are contemplated to be within the scope of the disclosure. For instance, in planting implementations, a planting plan may be loaded in similar manner to the memory 86, enabling the control system 18 (e.g., through the use of the applicator system software 92, among possibly other software and/or hardware modules) to determine the placement and soil treatment for each seed. As the planter traverses the field, the row head may prepare a small area for the seed, dispense the appropriate amount of fertilizer, dispense the seed, firm the soil, and possibly dispense herbicide. This process may be repeated for each seed necessary, where seed/row spacing is determined by the forward movement of the sprayer machine 10 (FIG. 1) and the transverse movement of a row head along the beam 40 (FIG. 4A).

Returning to the components of the control system 18, the processing unit 82 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the control system 18.

The I/O interfaces 84 provide one or more interfaces to the network 74 (FIG. 4A) and other networks (e.g., wireless networks, such as via radio frequency (RF)). In other words, the I/O interfaces 84 may comprise any number of interfaces for the input and output of signals (e.g., analog or digital data) for conveyance over the network 74. The input (via I/O interfaces 84) may comprise input by an operator (local or remote) through the user interface 80 (e.g., FIG. 4A, including a keyboard, joystick, steering wheel, switches, levers, or mouse or other input device (or audible input in some embodiments)), and input from signals carrying information from one or more of the components of the command and control system 72, such as the guidance system receiver 76 and/or machine controls 78, among other devices.

When certain embodiments of the control system 18 are implemented at least in part as software (including firmware), as depicted in FIG. 7B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the control system 18 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Having described certain embodiments of applicator systems 12, it should be appreciated within the context of the present disclosure that one embodiment of an applicator method (e.g., as implemented in one embodiment by the applicator system 12, though not limited to the specific structures shown in FIGS. 1-7B), denoted as method 98, and illustrated in FIG. 8, comprises receiving at an applicator transducer a signal to adjust a location of an applicator hose system along a beam from a first position to a second position (100). For instance, one embodiment of the applicator hose system 44 comprises a trolley system that is operably coupled to the applicator transducer by a cable and moves along the beam, a hose carrier configured to carry at least a portion of a hose, and an applicator that is coupled to one end of the hose carried by the hose carrier and operably coupled to the trolley system. The method 98 further comprises responsive to the signal, causing the applicator to move along the beam from the first position to the second position (102).

Any process descriptions or blocks in flow diagrams should be understood as merely illustrative of steps performed in a process implemented by an applicator system 12, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A system, comprising:
a boom and an applicator system coupled to the boom, the applicator system comprising:
a beam;
an applicator transducer coupled to the beam;
a conduit carrying a hose; and
an applicator hose system, the applicator hose system comprising:
a trolley system comprising a frame coupled to the applicator transducer by a cable, the applicator transducer configured to cause bi-directional movement of the frame based on movement of the cable, the trolley system configured to move along the beam according to the movement of the frame;
a hose carrier configured to carry at least a portion of the hose; and
an applicator that is coupled to both one end of the hose carried by the hose carrier and the frame, the applicator configured to move along with the frame.

2. The system of claim 1, wherein the beam comprises a uni-strut beam, the uni-strut beam comprising a slotted surface, wherein the uni-strut beam is adjustably secured to the boom using a U-bolt secured to the slotted surface.

3. The system of claim 2, wherein the trolley system further comprises one or more rollers, the rollers configured to rotate in cooperation with movement of the frame and move along an inner surface of the slotted surface.

4. The system of claim 1, wherein the hose carrier is configured to surround the hose and carry the hose in plural directions based on the movement of the frame.

5. The system of claim 1, wherein the frame is secured to opposing ends of the cable.

6. The system of claim 1, wherein the applicator comprises a spray nozzle assembly.

7. The system of claim 6, wherein the spray nozzle assembly comprises a rotatable body, the rotatable body coupled to one or more spray nozzles.

8. The system of claim 1, wherein the applicator comprises a planter.

9. The system of claim 1, wherein the applicator transducer comprises a pulley and a drive system that causes rotation of the pulley, the pulley causing the movement of the cable.

10. The system of claim 1, further comprising a control system configured to control operations of the applicator transducer.

11. An applicator system, comprising:
a beam;
an applicator transducer;
an applicator hose system coupled to the beam and the applicator transducer, the applicator hose system comprising:
a trolley system configured to move bi-directionally along the beam based on a cable-pulling operation of the applicator transducer;
a hose carrier configured to carry at least a portion of a hose; and
an applicator that is coupled to one end of the hose carried by the hose carrier and operably coupled to the trolley system.

12. The applicator system of claim 11, further comprising a conduit carrying at least a portion of the hose.

13. The applicator system of claim 11, wherein the trolley system comprises a frame that is secured to opposing end of a cable, the frame moveable in plural directions based on the movement of the cable.

14. The applicator system of claim 11, wherein the applicator comprises a spray nozzle assembly.

15. The applicator system of claim 14, wherein the spray nozzle assembly comprises one or more spray nozzles having different operating specifications.

16. The applicator system of claim 11, wherein the applicator comprises a planter.

17. The applicator system of claim 11, wherein the applicator transducer comprises a pulley and a drive system that causes rotation of the pulley, the pulley causing the movement of a cable.

18. An applicator method, comprising:
receiving at an applicator transducer a signal to adjust a location of an applicator hose system along a beam from a first position to a second position, the applicator hose system comprising a trolley system that is operably coupled to the applicator transducer by a cable and moves along the beam, a hose carrier configured to carry at least a portion of a hose, and an applicator that is coupled to one end of the hose carried by the hose carrier and operably coupled to the trolley system; and
responsive to the signal, causing the applicator to move along the beam from the first position to the second position.

19. The method of claim 18, further comprising receiving a second signal to adjust the applicator hose system along the beam from the second position to a third position, wherein movement from the second position to the third position is in an opposite direction than movement from the first position to the second position.

20. The method of claim 18, wherein the applicator comprises a spray nozzle assembly configured to spray fluid at each position.
